(19) United States
(12) Patent Application Publication
(10) Pub. No.: US 2026/0139117 A1
(43) Pub. Date: May 21, 2026

(54) MECHANOCATALYTIC DEPOLYMERIZATION OF PLASTICS

(71) Applicant: Georgia Tech Research Corporation, Atlanta, GA (US)

(72) Inventors: Carsten Sievers, Atlanta, GA (US); Andrew W. Tricker, Atlanta, GA (US); Sankar Nair, Atlanta, GA (US); Christopher Jones, Atlanta, GA (US); Fani Boukouvala, Atlanta, GA (US)

(21) Appl. No.: 19/447,359

(22) Filed: Jan. 13, 2026

Related U.S. Application Data
(63) Continuation of application No. 17/801,027, now Pat. No. 12,528,927.
(60) Provisional application No. 62/979,250, filed on Feb. 20, 2020.

(51) Int. Cl. C08J 11/16

(52) U.S. Cl. CPC C08J 11/16; C08J 2367/02

(57) ABSTRACT

Systems and methods for recycling polymers. A method for recycling synthetic polymers by combining the polymers with a solid depolymerizing catalyst in a vessel, mechanically shearing the combined polymers and the solid depolymerizing catalyst against each other to produce monomers from the polymers; and collecting the monomers. The solid depolymerizing catalyst can be solid sodium hydroxide. Collecting the monomers can be achieved by contacting the sheared polymer and catalyst with a recyclable volatile solvent to dissolve the monomers. The method can include purifying the collected monomers for repolymerization. Purifying the monomers can be achieved using nanofiltration membrane technology, cyclic fixed bed adsorption, simulated moving-bed adsorption or a combination thereof.

### CROSS-REFERENCE TO RELATED APPLICATIONS

This application is a continuation of, and claims priority under 35 USC § 120 to, U.S. patent application Ser. No. 17/801,027 filed 19 Aug. 2022, which application Ser. No. 17/801,027 is a § 371 National Stage of International Patent Application No. PCT/US 2021/019022, with an international filing date of 22 Feb. 2021, which International Patent Application No. PCT/US 2021/019022 claims benefit under 35 USC § 119(e) of US Provisional Ser. No. 62/979,250 filed 20 Feb. 2020, the entirety of each of which is incorporated herein by reference as if fully set forth below.

### STATEMENT REGARDING FEDERALLY SPONSORED RESEARCH OR DEVELOPMENT

Not Applicable

### SEQUENCE LISTING

Not Applicable

STATEMENT REGARDING PRIOR DISCLOSURES BY THE INVENTOR OR A JOINT INVENTOR

Not Applicable

### BACKGROUND OF THE DISCLOSURE

### 1. Field of the Invention

Aspects of the invention are directed to the recycling of polymers such as poly(ethylene terephthalate).

### 2. Description of Related Art

Chemical recycling of poly(ethylene terephthalate) (PET) has gained increasing attention in context of environmental impacts and the circular economy. Monomeric or oligomeric products of PET can conventionally be obtained by hydrolysis, alcoholysis, and glycolysis, using homogeneous acids (H₂SO₄, HNO₃), bases (NaOH), or soluble metal acetates. However, significant challenges exist in the economics of such processes, both in depolymerization as well as separations costs. Rather than pursue incremental improvements in the economics of conventional processes, a significant paradigm change is necessary.

In industrial processes, heterogeneous (i.e., solid) catalysts are generally preferred because they can be easily separated from products and residual reactants. However, during solid feedstock conversion, it is challenging to provide sufficient catalyst-feed contact. Mechanocatalytic depolymerization (using ball mills) is an unconventional approach to process solid feedstocks with a solid catalyst in an economically viable way that does not require solvents. While there are gaps in the fundamental understanding of mechanochemistry, mechanocatalytic depolymerization has been demonstrated on a lab scale for lignocellulosic biomass, cellulose, lignin, and chitin. In addition to the attractiveness of chemical depolymerizing plastics essentially in the solid phase, ball milling is a highly scalable industrial process, and its many applications include the production of several billion tons/year of cement (FIG. 1A). Ball mills operate with electrical energy, and are thus also compatible with the increasing availability of electricity from renewable sources. Mechanocatalysis thus has many advantages over other unconventional approaches such as biological depolymerization by microbes/enzymes, which must overcome large challenges in productivity, resistance to contaminants, and separations especially when handling mixed-waste feedstocks.

In catalytic ball milling, mechanical forces are used to shear reactants and catalysts against each other, creating an intimate contact as well as providing energy required for reactions. Recent work demonstrated mechanochemical depolymerization of lignin (FIG. 1B), resulting in mostly monomeric and dimeric products using solid NaOH as a base catalyst and a few drops of methanol as a stabilizer for reactive intermediates. Chemical reactions are accelerated as explained by various mechanisms, e.g., generation of “hot spots”, formation of highly active catalytic sites, and triboelectric effects. For example, recent experimental and modeling studies show that transient “hot spots” (>1100 ° K) are generated when CaCO₃ is milled with steel balls to form CaO and CO₂. Schath and co-workers demonstrated that milling with Cr₂O₃ catalysts created highly active sites for CO oxidation to CO₂ (Rashidi, F., et al., ACS Sustainable Chemistry & Engineering 5:1002-1009 (2016)). The effects of different mechanisms can vary depending on the specific process of interest.

Polymer recycling also requires processing steps for product separation and reactant/feedstock recycle. Greater complexity is created in mixed feedstocks, e.g., PET containing smaller amounts of poly(amide)s (nylon), cellulosics (cotton/rayon), or PVC. This results in complex multicomponent products that contain monomers, partially depolymerized species, and well as unreacted colloidal species resulting from the non-PET components. So far, PET recycling processes have used conventional, energy and capital-intensive separation processes (including distillation), which have a negative technoeconomic impact.

Economical separation of complex multicomponent liquid streams in harsh environments has recently been addressed through the development of robust membranes and adsorbents. A robust graphene oxide (GO) membrane technology economically fractionate complex and corrosive kraft black liquor streams from wood pre-treatment-a highlight being the validation of the technology over 1,500 hours of continuous operation in real black liquor feeds has recently been described. High-performance continuous adsorption processes are also being developed to separate renewable aromatic (furanic) monomers from multicomponent reaction mixtures. Additionally, process systems engineering is necessary to explore and identify the most viable combination of units and optimize the technoeconomic viability. Such an approach involves modeling of unit operations (i.e., reactor, separations and auxiliary units), identification of degrees of freedom of each process step and the connections between units; and integration of models to form a process superstructure that includes all possible alternative process configurations (e.g., separation before and/or after reaction, recycle streams, etc.). Once this superstructure is available, technoeconomic analysis coupled with mathematical programming could be used to identify optimal operation and new designs even in the presence of uncertainty.

Thus, there is a need for new systems and methods for recycling polymers.

### BRIEF SUMMARY OF THE INVENTION

In an exemplary embodiment, the present invention is a method for depolymerizing synthetic polymers comprising milling a synthetic polymer and a catalyst, wherein the synthetic polymers are depolymerized into monomers, recovering at least a portion of a solid fraction, introducing at least a portion of the recovered solid fraction into water, wherein the catalyst and soluble monomer products are dissolved into the water producing a liquid comprising dissolved catalyst and soluble monomer products, and precipitating at least a portion of the soluble monomer products from the liquid.

In any exemplary embodiment, the milling can comprise milling the synthetic polymer, a stabilizer for reaction intermediates, and a catalyst in a milling vessel with a grinding ball.

In any exemplary embodiment, the method can further comprise purifying the soluble monomer products for use in synthetic polymer products.

In another exemplary embodiment, the present invention is a method for recycling synthetic polymers from solid mixed textile waste comprising combining a solid mixed textile waste feedstock with a solid depolymerizing catalyst in a vessel, mechanically shearing the combined solid mixed textile waste feedstock and the solid depolymerizing catalyst against each other to produce monomers from polymers present in the solid mixed waste feedstock, collecting at least a portion of the monomers, purifying at least a portion of the collected monomers, and repolymerizing at least a portion of the purified monomers into synthetic polymers for repurposing.

In any exemplary embodiment, the solid mixed textile waste feedstock can comprise at least one of polyethylene terephthalate (PET) or nylon.

In any exemplary embodiment, the monomers can comprise Bis(2-hydroxyethyl) terephthalate, dimethyl terephthalate, and terephthalic acid.

In any exemplary embodiment, the solid depolymerizing catalyst can be sodium hydroxide.

In another exemplary embodiment, the present invention is a method comprising milling polymer products and a solid catalyst, wherein at least a portion of the polymer products are depolymerized into monomers, recovering at least a portion of the solid catalyst and unreacted or partially reacted polymer products, and purifying at least a portion of the polymer product monomers and non-polymer monomers.

In any exemplary embodiment, the method can further comprise producing a slurry, and separating at least a portion of the polymer product monomers and non-polymer monomers from the slurry, wherein the solid catalyst is a solid depolymerizing catalyst, wherein the milling comprises milling in a milling vessel, wherein producing the slurry comprises introducing at least one of vaporized water or alcohol to the milling vessel, and wherein purifying is after separating.

In any exemplary embodiment, the at least a portion of the recovered solid depolymerizing catalyst can be configured to be used again in another cycle of recycling.

In any exemplary embodiment, the at least a portion of the unreacted or partially reacted polymer products can be configured to be used again in another cycle of recycling.

In any exemplary embodiment, the at least a portion of the purified polymer product monomers can be configured to be used as products or by-products to produce new polymer products.

In another exemplary embodiment, the present invention is a method comprising combining polymer products with a depolymerizing catalyst to produce depolymerized polymers, mechanically shearing the combined polymer products and the depolymerizing catalyst against each other to produce monomers, collecting the monomers, purifying the collected monomers for repolymerization, and producing a slurry from the monomers.

In any exemplary embodiment, the purifying can be selected from the group consisting of purifying via nanofiltration membrane technology, cyclic fixed bed adsorption, simulated moving-bed adsorption and a combination thereof.

In any exemplary embodiment, the slurry can comprise the monomers and at least one of water or alcohol.

In another exemplary embodiment, the present invention is a method comprising milling polymer products and a depolymerizing catalyst in a milling vessel with a grinding ball to produce depolymerized polymers and producing a slurry from the depolymerized polymers and at least one of water or alcohol, wherein the polymer products are synthetic polymer products that are depolymerized into monomers, and/or producing comprises introducing the at least one of the vaporized water or the alcohol into the milling vessel to produce the slurry.

In another exemplary embodiment, the present invention is a method comprising milling polymer products with a solid depolymerizing catalyst to produce depolymerized polymers, wherein at least a portion of the polymer products are depolymerized into monomers, producing a slurry from the depolymerized polymers, recovering at least a portion of the solid depolymerizing catalyst and unreacted or partially reacted polymer products from the slurry, separating at least a portion of the polymer product monomers and non-polymer monomers from the slurry, and purifying at least a portion of the polymer product monomers and non-polymer monomers, wherein milling comprises milling in a milling vessel and producing the slurry comprises introducing the water being vaporized water and the alcohol to the milling vessel.

In another exemplary embodiment, the present invention is a system for recycling synthetic polymers comprising a mechanochemical reactor, a mixing tank downstream of and in liquid communication with the mechanochemical reactor, a nanofiltration system downstream of and in liquid communication with the mixing tank, solvent dryers in liquid communication with both the mixing tank and the nanofiltration system, and optionally in liquid communication with the mechanochemical reactor, a crystallizer, chromatography column, or both downstream of and in liquid communication with the nanofiltration system, and a distillation unit downstream of and in liquid communication with the crystallizer, chromatography column, or both.

In any exemplary embodiment, the mechonochemical reactor can be a ball mill or a hammer mill.

In any exemplary embodiment, the crystallizer can be an evaporative crystallizer.

In any exemplary embodiment, the chromatography column can be a fixed bed or moving bed.

In any exemplary embodiment, the liquid communication between the system components can be one directional.

In another exemplary embodiment, the present invention is a method for recycling synthetic polymers by combining the polymers with a solid depolymerizing catalyst in a vessel, mechanically shearing the combined polymers and the solid depolymerizing catalyst against each other to produce monomers from the polymers; and collecting the monomers. In any exemplary embodiment, the solid depolymerizing catalyst is solid sodium hydroxide. In any exemplary embodiment collecting the monomers is achieved by contacting the sheared polymer and catalyst with a recyclable volatile solvent to dissolve the monomers. In any exemplary embodiment, the method includes purifying the collected monomers for repolymerization. In any exemplary embodiment purifying the monomers is achieved using nanofiltration membrane technology, cyclic fixed bed adsorption, simulated moving-bed adsorption or a combination thereof. Mechanically shearing the combined polymers and the solid depolymerizing catalyst against each other to produce monomers from the polymers comprises milling the combined polymers and the solid depolymerizing catalyst with a grinding ball.

In another exemplary embodiment, the present invention is a method for mechanochemically recycling synthetic polymer products by milling the synthetic polymer products and solid depolymerizing catalyst in a milling vessel with a grinding ball, wherein the synthetic polymer products are depolymerized into monomers, introducing vaporized water and/or alcohol into the milling vessel to produce a slurry, recovering the catalyst and unreacted or partially reacted synthetic polymer products from the slurry, wherein the catalyst and unreacted or partially reacted synthetic polymer products can be used again in another cycle of recycling, separating synthetic polymer product monomers and non-polymer monomers from the slurry, and purifying the synthetic polymer product monomers and non-polymer monomers, wherein the purified monomers are used as products or byproducts to produce new synthetic polymer products. In any exemplary embodiment, the synthetic polymer products include polyethylene terephthalate (PET). In any exemplary embodiment, the solid depolymerizing catalyst includes solid depolymerizing catalyst particles that can be recovered magnetically. For example, the solid depolymerizing catalyst can include surface-functionalized iron oxide nanoparticles. In any exemplary embodiment, the separating of the synthetic polymer product monomers and non-polymer monomers from the slurry includes contacting the slurry with a recyclable volatile solvent to dissolve the monomers. In any exemplary embodiment recovering the catalyst and unreacted or partially reacted synthetic polymer products from the slurry includes nanofiltration membrane technology to recycle high molecular weight catalysts and unreacted or partially reacted synthetic polymer products. For example, the nanofiltration membrane technology can be selected from the group consisting of graphene oxide nanofiltration, polyethersulfone nanofiltration, and fluoride nanofiltration. In any exemplary embodiment, separating synthetic polymer product monomers and non-polymer monomers from the slurry includes evaporative crystallization to concentrate the slurry, recover volatile solvent, and crystallize monomers, wherein different monomers crystallize at different concentrations and temperatures. In any exemplary embodiment, separating the synthetic polymer product monomers and non-polymer monomers from the slurry includes cyclic fixed bed adsorption or simulated moving-bed adsorption.

In another exemplary embodiment, the present invention is a method for depolymerizing synthetic polymers, by milling a synthetic polymer and a catalyst in a milling vessel with a grinding ball, wherein the synthetic polymers are depolymerized into monomers, recovering the solid fraction, introducing the solid fraction into water, wherein the catalyst and soluble monomer products are dissolved into the water producing a liquid comprising dissolved catalyst and soluble monomer products, and precipitating the soluble monomer products from the liquid. In any exemplary embodiment, the milling step further includes methanol as a stabilizer for reaction intermediates. In any exemplary embodiment include purifying the soluble monomer products for use in synthetic polymer products.

In another exemplary embodiment, the present invention is a system for recycling synthetic polymers, including a mechanochemical reactor; a mixing tank downstream of and in liquid communication with the mechanochemical reactor; a nanofiltration system downstream of and in liquid communication with the mixing tank, solvent dryers in liquid communication with both the mixing tank and the nanofiltration system, and optionally in liquid communication with the mechanochemical reactor, a crystallizer, chromatography column, or both downstream of and in liquid communication with the nanofiltration system; and a distillation unit downstream of and in liquid communication with the crystallizer, chromatography column, or both. In any exemplary embodiment, the mechonochemical reactor is a ball mill or a hammer mill, the crystallizer is an evaporative crystallizer, and chromatography column is fixed bed or moving bed. In any exemplary embodiment, the liquid communication between the system components is one directional.

In another exemplary embodiment, the present invention is a method for recycling synthetic polymers from solid mixed textile waste, by: combining a solid mixed textile waste feedstock with a solid depolymerizing catalyst in a vessel, mechanically shearing the combined solid mixed textile waste feedstock and the solid depolymerizing catalyst against each other to produce monomers from polymers present in the solid mixed waste feedstock, collecting the monomers, purifying the monomers; and repolymerizing the monomer into synthetic polymers for repurposing. In any exemplary embodiment, the solid mixed textile waste feedstock include polyethylene terephthalate (PET). In any exemplary embodiment, the monomers include bishydroxyethylene terephthalate, dimethyl terephthalate, and terephthalic acid. In any exemplary embodiment, the solid mixed textile waste feedstock includes one or more nylons. In any exemplary embodiment, the monomers include adipic acid, sebacic acid, dodecanedoic acid, terphthalic acid, isophtalic acid, tetramethylene diamine, hexamethylene diamine, 1,9-diaminononane, 2-methyl pentamethylene diamine, trimethyl hexamethylene diamine, m-xylylene diamine, and 1,5-pentanediamine. In any exemplary embodiment, the solid depolymerizing catalyst is sodium hydroxide.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features can also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A is a photograph of an industrial ball mill for cement production. FIG. 1B is a line graph for mechanocatalytic lignin depolymeration. FIG. 1C is an exemplary lab-scale mill system.

FIG. 2 shows an exemplary base case continuous process flowsheet for mixed-waste PET recycling by mechnocatalyic depolymerization and product separations.

FIG. 3 shows a representative flowsheet superstructure including potential alternative steps.

### DETAILED DESCRIPTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

As used herein, the term “about” or “approximately” means, for example, within 10%, within 5%, or less. In some embodiments, the term “about” can mean within measurement error. In this regard, when described or claimed, all numerical values may be read as if preceded by the word “about” or “approximately,” even if the term is not explicitly stated. The phrase “about” or “approximately,” when describing a size and/or location, may be used to indicate that the stated value and/or location is within a reasonable expected range of value and/or location. For example, a numerical value may include values that are ±0.1% of the stated value (or range of values), ±1% of the stated value (or range of values), ±2% of the stated value (or range of values), ±5% of the stated value (or range of values), ±10% of the stated value (or range of values), etc. As described herein, all numerical ranges are intended to include the endpoints and all subranges therein, unless specifically stated otherwise.

As used herein, the term “substantially” means allowing for deviations from a descriptor that do not adversely affect the intended purpose. For example, deviations resulting from measurement limitations, differences within manufacturing tolerances, or variations of less than 5% can be considered to be within substantially the same range. The specified descriptors can be absolute (e.g., substantially spherical, substantially perpendicular, substantially concentric, etc.) or relative (e.g., substantially similar, substantially the same, etc.).

Similarly, as used herein, “substantially free” of something, or “substantially pure,” and like characterizations, can include both being “at least substantially free” of something, or “at least substantially pure,” and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

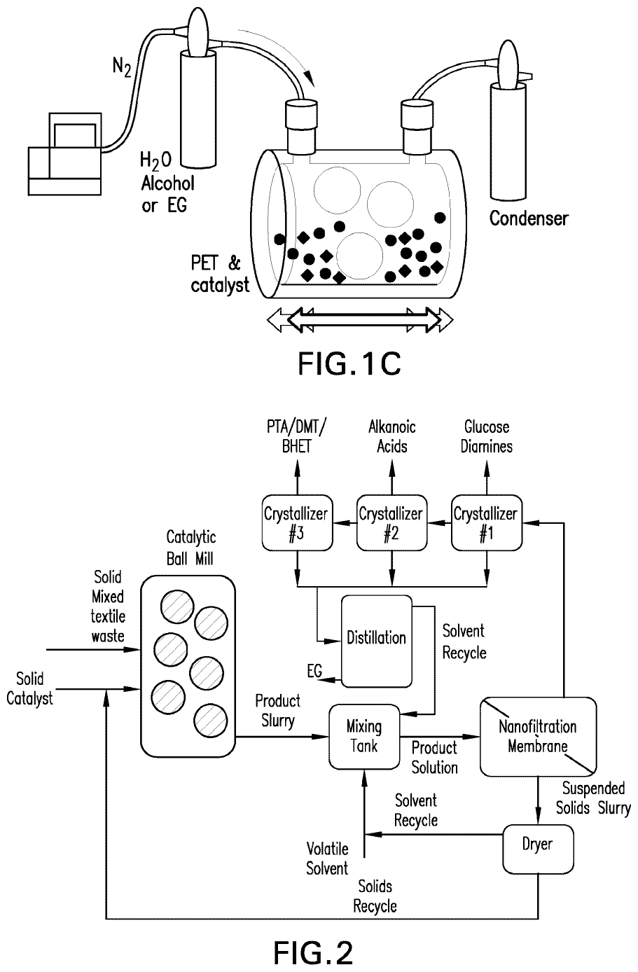

One embodiment of the present invention provides a continuous process combining a mechanocatalytic reactor with separation processes based mainly upon membranes and crystallization is provided. The objectives will have a significant concurrency due to the integral approach pursued. The “base case” process flowsheet (FIG. 2), defines a “superstructure” of process integration alternatives, refine the “best” alternative via technoeconomic metrics and optimization.

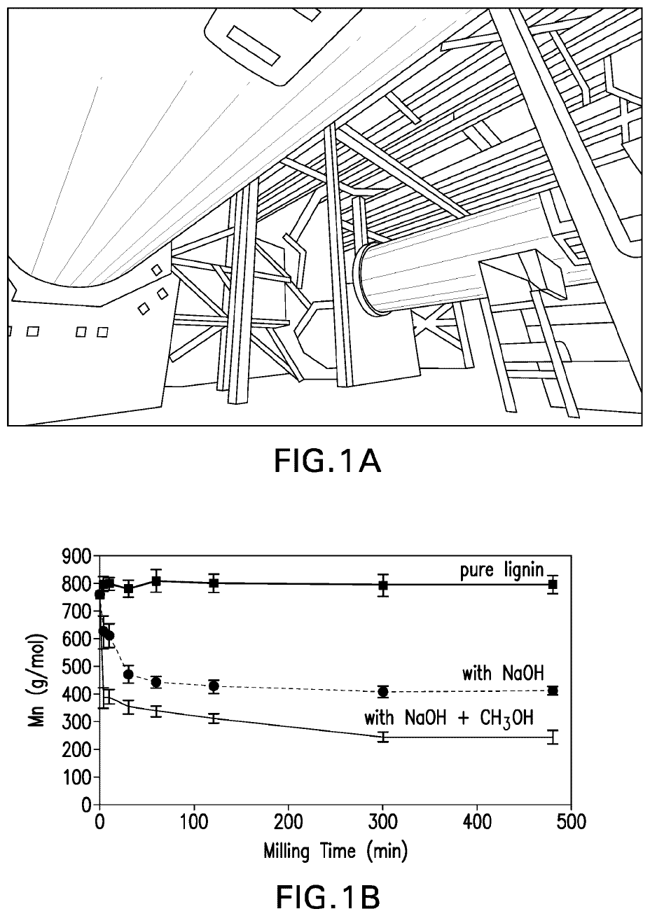

In some embodiments a mechanocatalytic process can be used to depolymerize PET into monomers. For this purpose, PET will be processed in shaker ball mill (FIG. 1C) with solid acid catalysts (e.g., iron oxide nanoparticles' or surface-functionalized iron oxide nanoparticles which can be recovered magnetically) and milling balls made from stainless steel or other hard materials. There is one previous report using iron oxide nanoparticles to depolymerize PET, but in the absence of mechanical forces (Bartolome, L., et al., Green Chemistry, 16, 279-286 (2014)). Co-reactants (water/alcohols/ethylene glycol) can be provided as vapors in a carrier gas stream, because excessive liquid would buffer the mechanical impact of collisions. Due to the high melting points of the monomers (DMT: 141° C., BHET: 106° C., PTA: 427° C.), depolymerization will result in catalyst particles coated with mostly solid products. Other monomers such as ethylene glycol (from PET) and hexamethylenediamine (from nylon) would likely be in liquid form, so that the product can be generally assumed to be a concentrated slurry. This “solid”/“slurry” phase depolymerization with minimal liquid products is attractive for scalability, since it creates a strong potential of directly using existing continuous ball mill technology. The process can be performed in batch mode in a shaker ball mill, but other types of mills would be used for eventual scale-up and continuous operation. The compositions of liquid or soluble reaction products will be quantified by NMR spectroscopy or chromatography (GC/HPLC). Targeting nanoparticles can be used with the addition of different types and concentrations of Bronsted and/or Lewis acid sites by design.

In one embodiment the following classes of components can be present in the product mixture: (1) catalysts, (2) unreacted/partially reacted feedstock, (3) PET monomers, and (4) non-PET monomers (amines, adipic/other alkanoic dicarboxylic acids, glucose). Additionally, an easily recyclable (volatile) green solvent (e.g., ethanol, ethyl acetate) can be added in minimum required quantity to the product slurry after it exits the ball mill, to dissolve the monomers and enable separations processes (FIG. 2).

As shown, classes (1) and (2) would be recovered and recycled to the reactor, and classes (3) and (4) would be purified as desired products/byproducts. The added solvent would be recovered and recycled. A robust graphene oxide (GO) nanofiltration membrane technology can be used to recycle high-molecular weight classes (1) and (2), with a dryer included for residual solvent removal. These GO membranes are stable in extreme chemical environments, with molecular weight cutoffs (MWCOs) tunable from about 1000 Da to about 100 Da, and much lower fouling than polymeric membranes. They were originally developed for fractionating kraft black liquor, which is a high-solids byproduct of biomass depolymerization and contains a similar species distribution (polymers, oligomers, monomers). In some embodiments, magnetic stirrers can be used. Next, the clarified permeate stream from the membrane is separated by evaporative crystallizers to concentrate the solution, recover additional volatile solvent, and crystallize the dicarboxylic acids (terephthalic from PET, and alkanoic from nylon) and diamines (from nylon) at different operating concentrations/temperatures.

Since the crystallizers are operating with a volatile organic solvent (low heat of vaporization), energy consumption is expected to be much lower than for monomer crystallizations from aqueous solvents in biological depolymerizations. The crystallization processes can be demonstrated using simple rotary evaporators (rotovaps). The stream exiting the final crystallization step will contain ethylene glycol and volatile solvent, which will be separated by a final distillation step. Again, this is expected to have a low cost due to the large volatility difference between the two components. In one embodiment, an alternative to crystallizers is to use adsorption processes-either cyclic fixed bed or continuous simulated moving bed (SMB)—for recovering monomers.

Two major challenges towards the development of an integrated process flowsheet are: (1) a systems-level analysis of critical decisions and linking variables across process units and (2) integration of different fidelity models using a combination of physics-based and data-driven reduced-order models. The present invention involves close collaboration between the modeling and experimental groups. All the experimental data and known physics-based models of reactors and separators can be combined and translated into a series of integrated base-case process flowsheets.

The model detail can be sufficient to capture the limits of each unit, but maintain tractability of the systems-level process synthesis optimization problem. For example, the final distillation step is easily modeled through established mass-balance and equilibrium equations, whereas the mechanocatalytic reactor model will consist of data-driven correlations/kinetic models developed using the obtained data. This hybrid physics-based and data-driven approach” can accelerate process development even without “full fundamental knowledge” of each process unit.

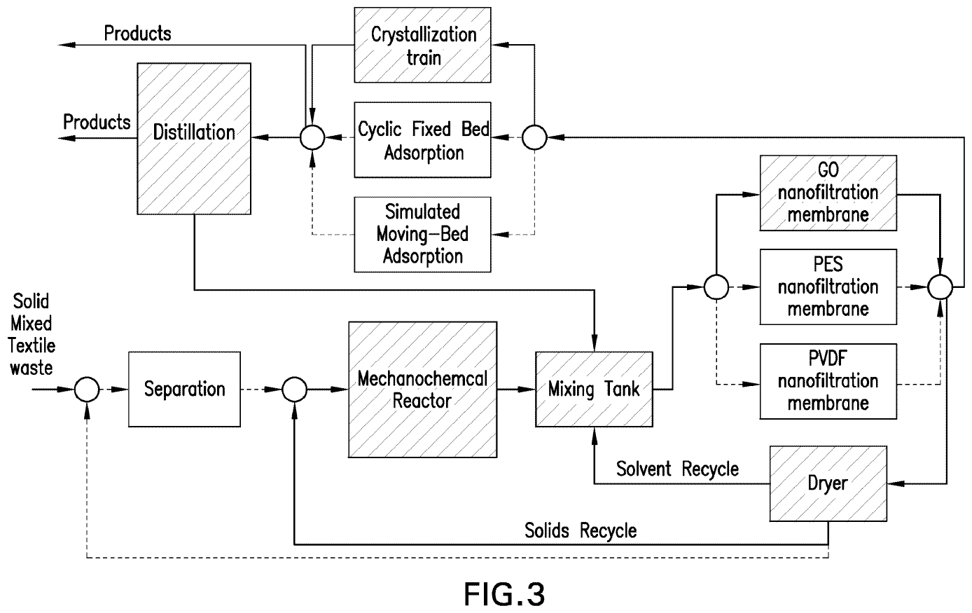

FIG. 3 discloses still another embodiment that includes process alternatives and potential stream connections (i.e., a combination of all of possible base-case flowsheets). This model, coupled with Mixed-Integer Nonlinear Programming (i.e., the introduction of yes/no decision variables that select/deactivate a process step) can be used to identify the optimal process alternative for typical compositions of solid plastic feedstocks and different objectives and constraints. This framework can be used to answer important questions, e.g., (a) Which process configuration is most robust to feed variations while satisfying product specifications; (b) Is a different optimal process configuration favored when an economic/cost objective versus an energy efficiency objective is enforced.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

What is claimed is:

1. A method comprising:
combining polymer products with a depolymerizing catalyst;
mechanically shearing the combined polymer products and the depolymerizing catalyst against each other;
collecting at least a portion of monomers formed by the mechanically shearing; and
purifying at least a portion of the collected monomers.

2. The method of claim 1 further comprising:
repolymerizing at least a portion of the purified monomers.

3. The method of claim 1 further comprising:
producing a slurry from the monomers.

4. The method of claim 2, wherein:
the polymer products are solid mixed textile waste feedstock;
the depolymerizing catalyst is a solid depolymerizing catalyst;
mechanically shearing comprises mechanically shearing the combined solid mixed textile waste feedstock and the solid depolymerizing catalyst against each other to produce the monomers from polymers present in the solid mixed waste feedstock;
repolymerizing comprises repolymerizing the at least a portion of the purified monomers into synthetic polymers for repurposing; and
the method is a method for recycling synthetic polymers from solid mixed textile waste.

5. The method of claim 3, wherein:
the combining produce depolymerized polymers;
the purifying:
comprises purifying the at least a portion of the collected monomers for repolymerization; and
is selected from a group consisting of purifying via nanofiltration membrane technology, cyclic fixed bed adsorption, simulated moving-bed adsorption and a combination thereof.

6. The method of claim 3, wherein producing the slurry comprises producing a slurry from the monomers and at least one of water or alcohol.

7. The method of claim 4, wherein the solid mixed textile waste feedstock comprises at least one of polyethylene terephthalate (PET) or nylon.

8. The method of claim 4, wherein the monomers comprise at least one of Bis(2-hydroxyethyl) terephthalate, dimethyl terephthalate, or terephthalic acid.

9. The method of claim 4, wherein the solid depolymerizing catalyst is sodium hydroxide.

10. A method comprising:
milling polymer products and a solid catalyst, wherein at least a portion of the polymer products are depolymerized into monomers;
recovering at least a portion of the solid catalyst and unreacted or partially reacted polymer products; and
purifying at least a portion of the polymer product monomers and non-polymer monomers.

11. The method of claim 10 further comprising:
producing a slurry; and
separating at least a portion of the polymer product monomers and non-polymer monomers from the slurry.

12. The method of claim 11, wherein:
the solid catalyst is a solid depolymerizing catalyst;
the milling comprises milling in a milling vessel;
the producing the slurry comprises introducing at least one of vaporized water or alcohol to the milling vessel; and
the purifying is after separating.

13. The method of claim 12, wherein at least one of:
at least a portion of the recovered solid depolymerizing catalyst is configured to be used again in another cycle of recycling;
at least a portion of the unreacted or partially reacted polymer products are configured to be used again in another cycle of recycling; or
at least a portion of the purified polymer product monomers are configured to be used as products or by-products to produce new polymer products.

14. A method comprising:
milling polymer products and a catalyst to produce depolymerized polymers; and
mixing at least one of water or alcohol with the depolymerized polymers to produce a slurry.

15. The method of claim 14, wherein:
the catalyst is a depolymerizing catalyst;
the milling comprise milling the polymer products and the depolymerizing catalyst in a milling vessel with a grinding ball to produce the depolymerized polymers;
the polymer products are synthetic polymer products that are depolymerized into monomers; and
the mixing comprises introducing the at least one of the water being vaporized water or the alcohol into the milling vessel to produce the slurry.

16. The method of claim 14 further comprising:
recovering at least a portion of the catalyst and unreacted or partially reacted polymer products from the slurry;
separating at least a portion of the polymer product monomers and non-polymer monomers from the slurry; and
purifying at least a portion of the polymer product monomers and non-polymer monomers.

17. The method of claim 16, wherein:
the catalyst is a solid depolymerizing catalyst;
the milling comprises milling the polymer products with the solid depolymerizing catalyst in a milling vessel to produce the depolymerized polymers, wherein at least a portion of the polymer products are depolymerized into monomers; and
the mixing comprises introducing the at least one of the water being vaporized water or the alcohol into the milling vessel to produce the slurry.

18. A system for recycling synthetic polymers comprising:
a mechanochemical reactor;
a mixing tank downstream of and in liquid communication with the mechanochemical reactor;
a nanofiltration system downstream of and in liquid communication with the mixing tank;
solvent dryers in liquid communication with both the mixing tank and the nanofiltration system, and optionally in liquid communication with the mechanochemical reactor;
a crystallizer, chromatography column, or both downstream of and in liquid communication with the nanofiltration system; and
a distillation unit downstream of and in liquid communication with the crystallizer, chromatography column, or both.

19. The system of claim 18, wherein at least one of:
the mechonochemical reactor is a ball mill or a hammer mill;
the crystallizer is an evaporative crystallizer;
the chromatography column is fixed bed or moving bed; or
the liquid communication between the system components is one directional.
